(19) United States
(12) Patent Application Publication
(10) Pub. No.: US 2020/0367142 A1
(43) Pub. Date: Nov. 19, 2020

(54) ELECTRONIC APPARATUS AND METHOD FOR CONTROLLING THE SAME

(71) Applicant: Samsung Electronics Co., Ltd., Suwon-si, Gyeonggi-do (KR)

(72) Inventors: Changgun KO, Suwon-si (KR); Hoejin KWEN, Suwon-si (KR); Hyunsuk MIN, Suwon-si (KR)

(73) Assignee: Samsung Electronics Co., Ltd., Suwon-si, Gyeonggi-do (KR)

(21) Appl. No.: 16/959,784

(22) PCT Filed: Dec. 27, 2018
(86) PCT No.: PCT/KR2018/016710

§ 371 Date: Jul. 2, 2020

(30) Foreign Application Priority Data
Jan. 4, 2018 (KR) 10-2018-0001154

(51) Int. Cl. H04W 48/04; H04W 76/14; H04W 12/00; H04L 29/06; H04W 48/16; H04W 8/00; H04W 12/08

(52) U.S. Cl. CPC H04W 48/04; H04W 76/14; H04W 12/00503; H04W 12/08; H04W 48/16; H04W 8/005; H04L 63/101

(57) ABSTRACT

Disclosed are an electronic device, a method for controlling the same, and a computer program product therefor. The electronic device includes: a communicator configured to communicate with at least one external apparatus; and a processor configured to: control the communication unit to start a connection with the at least one external apparatus, acquire location information on an object detected in a vicinity of the electronic apparatus, accept the started connection depending on whether the object exists in a zone in which the connection is allowed, based on the acquired location information, and transmit to the external apparatus information for completing the connection based on the connection being allowed. Accordingly, it is possible to enhance security, lighten a management burden imposed on the electronic apparatus, and reduce the time required to establish a wireless connection.

### TECHNICAL FIELD

The disclosure relates to an electronic apparatus and a control method thereof, and more particularly, to an electronic apparatus which is wirelessly connected to an external apparatus, and a control method thereof.

### BACKGROUND ART

An electronic apparatus is able to be wirelessly connected to another apparatus. There are various types of wireless connection such as ZigBee, Bluetooth and Wi-Fi.

When a user intends to wirelessly connect an electronic apparatus to an external apparatus, he/she selects the external apparatus, to which the electronic apparatus is wirelessly connected, by various methods. In the process of carrying out a wireless connection between an external apparatus and an electronic apparatus, a security key for wireless connection may be exposed. If the security key is exposed, the electronic apparatus may be wirelessly connected to an external apparatus which a user does not wirelessly connect to the electronic apparatus, and personal information is likely to be divulged. In particular, if a security key of an electronic apparatus, which is connected to many external apparatuses, is divulged, great damage may arise.

A user may designate apparatuses, which he/she desires to connect to an electronic apparatus, and may connect only the designated apparatuses to the electronic apparatus. However, the aforementioned method is inconvenient in managing an electronic apparatus which is to be wirelessly connected to numerous external apparatuses.

Therefore, it is necessary to find a method for wirelessly connecting an electronic apparatus to external apparatuses as desired by a user while a security key of the electronic apparatus is not divulged.

### Technical Problem

An aspect of the disclosure is to solve the conventional problems described above, and provide an electronic apparatus which minimizes an exposure of a security key at the time of a wireless connection and performs a wireless connection to an external apparatus that a user desires to connect, and a control method and a computer program product thereof.

Another aspect of the disclosure is to provide an electronic apparatus which may reduce a burden of management for performing a wireless connection, and a control method and a computer program product thereof.

Another aspect of the disclosure is to provide an electronic apparatus which reduces a time necessary for performing a wireless connection, and a control method and a computer program product thereof.

### Technical Solution

According to an embodiment of the disclosure, there is provided an electronic apparatus. The electronic apparatus includes: a communicator configured to communicate with at least one external apparatus; and a processor configured to: control the communicator to start a connection with the at least one external apparatus, acquire location information on an object detected in a vicinity of the electronic apparatus, accept the started connection depending on whether the object exists in a zone in which the connection is allowed, based on the acquired location information, and transmit to the external apparatus information for completing the connection based on the connection being allowed. Accordingly, security of the electronic apparatus may be improved in the course of a wireless connection.

The processor may be configured to identify whether the object exists in the zone in which the connection is allowed, within a predetermined connection allowance time.

Accordingly, a user may selectively perform a wireless connection of an external apparatus, which a user desires to wireless connect, with the electronic apparatus.

The electronic apparatus may further include an output unit configured to output an audio or an image, and the processor may be configured to output the zone in which the connection is allowed, through the output unit. Accordingly, a user may conveniently perform a wireless connection.

The processor may be configured to transmit information on the zone in which the connection is allowed, to enable another external apparatus to output the zone in which the connection is allowed. Accordingly, security for wireless connection may be further improved.

The electronic apparatus may further include a user input configured to receive a user's input, and the processor may be configured to set the zone in which the connection is allowed, corresponding to a received user's input. Accordingly, security for wireless connection may be further improved.

The processor may be configured to set the zone in which the connection is allowed, by using an external apparatus rather than the electronic apparatus. Accordingly, security for wireless connection may be further improved.

The processor may be configured not to perform a connection based on two or more objects being existed. Accordingly, security for wireless connection may be further improved.

The processor may be configured not to perform a connection with the external apparatus based on a distance of the external apparatus from the electronic apparatus exceeding a threshold value at the time when at least one external apparatus attempts to be connected to the electronic apparatus. Accordingly, security for wireless connection may be further improved.

In a situation where the object does not exist in the zone in which the connection is allowed, based on the external apparatus attempting to be connected to the electronic apparatus, the processor may be configured to block the connection attempted by the external apparatus, store identification information on the external apparatus which has attempted to be connected, and block a connection subsequently attempted by the external apparatus based on the stored identification information. Accordingly, security for wireless connection may be further improved.

According to another embodiment of the disclosure, there is provided a method for controlling an electronic apparatus. The method includes: controlling a communicator which may communicate with at least one external apparatus to start a connection with at least one external apparatus; acquiring location information on an object detected in a vicinity of the electronic apparatus; allowing the started connection depending on whether the object exists in a zone in which the connection is allowed, based on the acquired location information; and transmitting information for completing the connection to the at least one external apparatus, based on the started connection being allowed. Accordingly, security of the electronic apparatus may be improved in the course of a wireless connection.

The method may further include determining whether the object exists in the zone in which the connection is allowed, within a predetermined connection allowance time. Accordingly, a user may selectively perform a wireless connection of an external apparatus, which a user desires to wireless connect, with the electronic apparatus.

The method may further include outputting the zone in which the connection is allowed, through an output unit for outputting an audio or an image. Accordingly, a user may conveniently perform a wireless connection.

The method may further include transmitting information on the zone in which the connection is allowed, to output by another external apparatus the zone in which the connection is allowed. Accordingly, security for wireless connection may be further improved.

The method may further include setting the zone in which the connection is allowed, corresponding to a user's input received through a user input. Accordingly, security for wireless connection may be further improved.

The method may further include setting the zone in which the connection is allowed, by using an external apparatus rather than the electronic apparatus. Accordingly, security for wireless connection may be further improved.

The method may further include not performing a connection based on two or more objects being existed. Accordingly, security for wireless connection may be further improved.

The method may further include not performing a connection with the external apparatus based on a distance of the external apparatus from the electronic apparatus exceeding a threshold value at the time when at least one external apparatus attempts to be connected to the electronic apparatus. Accordingly, security for wireless connection may be further improved.

In a situation where the object does not exist in the zone in which the connection is allowed, based on the external apparatus attempting to be connected to the electronic apparatus, the method may further include blocking the connection attempted by the external apparatus, storing identification information on the external apparatus which has attempted to be connected, and blocking a connection subsequently attempted by the external apparatus based on the stored identification information. Accordingly, security for wireless connection may be further improved.

According to other embodiment of the disclosure, there is provided a computer program product. The computer program product includes a memory configured to store instructions, and a process, and the instructions are configured to control, via a communicator configured to communicate with at least one external apparatus, to start a connection with the at least one external apparatus, acquire location information on an object detected in a vicinity of an electronic apparatus, accept the started connection depending on whether the object exists in a zone in which the connection is allowed, based on the acquired location information, and transmit to the external apparatus information for completing the connection based on the connection being allowed. Accordingly, security of the electronic apparatus may be improved in the course of a wireless connection.

### Advantageous Effects

As described above, according to the disclosure, security may be improved at the time when a wireless connection between an electronic apparatus and an external apparatus is performed.

According to the disclosure, a burden of management for performing a wireless connection of an electronic apparatus may be reduced.

According to the disclosure, time necessary for performing a wireless connection may be reduced.

### DESCRIPTION OF DRAWINGS

FIG. 1 illustrates an electronic apparatus according to an embodiment of the disclosure.

FIG. 2 illustrates a connection structure between an electronic apparatus and an external apparatus according to the embodiment of the disclosure.

FIG. 3 is a block diagram of an electronic apparatus according to the embodiment of the disclosure.

FIG. 4 is a flowchart showing operations of an electronic apparatus according to an embodiment of the disclosure.

FIG. 5 illustrates a location predetermined by an electronic apparatus according to an embodiment of the disclosure.

FIG. 6 illustrates operations of an electronic apparatus depending on a location of an object according to an embodiment of the disclosure.

FIG. 7 illustrates operations of an electronic apparatus according to an embodiment of the disclosure.

FIG. 8 illustrates an operation of outputting a predetermined location by an electronic apparatus according to an embodiment of the disclosure.

FIG. 9 illustrates operations of an electronic apparatus according to an embodiment of the disclosure.

FIG. 10 illustrates operations of an electronic apparatus according to an embodiment of the disclosure.

FIG. 11 illustrates operations of an electronic apparatus according to an embodiment of the disclosure.

FIG. 12 is a flowchart showing operations of an electronic apparatus according to an embodiment of the disclosure.

FIG. 13 illustrates an operation of adding a blacklist by an electronic apparatus according to an embodiment of the disclosure.

FIG. 14 illustrates a content output by an electronic apparatus according to an embodiment of the disclosure.

### BEST MODE

Below, embodiments of the disclosure will be described in detail with reference to accompanying drawings. In drawings, like numerals or marks refer to elements that substantially perform like functions, and the size of each element may be exaggerated for clarity of description and for convenience. The technical idea, key configuration and effect of the disclosure are not limited to the configuration or effect described in embodiments set forth below. If it is determined that any detailed description on a known technology or configuration related to the disclosure may unnecessarily blur the gist of the disclosure, such detailed description will be omitted.

In embodiments of the disclosure, terms containing ordinal numbers such as first and second are used only for distinguishing an element from other elements, and the singular also includes the plural unless the context requires otherwise. In embodiments of the disclosure, terms ‘consist of’, ‘include’, and ‘have’ must be understood as not excluding in advance the likelihood of existence of addition of one or more other characteristics, numbers, steps, operations, elements, components or combinations of the foregoing. In embodiments of the disclosure, the term ‘module’ or ‘unit’ refers to the one performing at least one function or operation, and the one that may be implemented as hardware or software or a combination of hardware and software, and may be integrated as at least one module to be implemented as at least one processor.

In this specification, at least one of a plurality of elements refers to not only all of the plurality of elements but also a single element out of the plurality of elements or a combination of the foregoing.

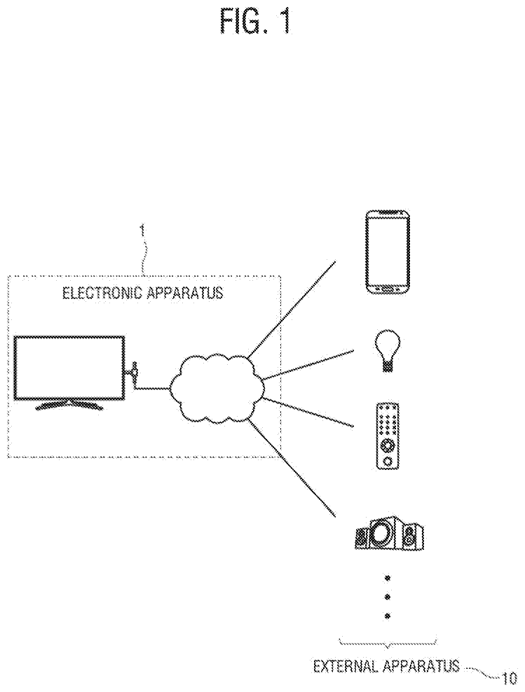

FIG. 1 illustrates an electronic apparatus according to an embodiment of the disclosure. An electronic apparatus 1 according to the embodiment of the disclosure may include, e.g. home appliances such as a television, mobile phone and a refrigerator, or a set-top box. The electronic apparatus according to the embodiment of the disclosure is not limited to the foregoing, and may be implemented as a server other than home appliances such as a television, mobile phone and refrigerator or a set-top box. To provide a predetermined function to a user, the electronic apparatus 1 may be wirelessly connected to (hereinafter, to be also called ‘pairing’) at least one external apparatus 10. For example, the electronic apparatus 1 may perform a wireless connection to the external apparatus 10 by various methods by using the Internet of Things (IoT).

The external apparatus 10 which is wirelessly connected to the electronic apparatus 1 according to the embodiment of the disclosure may include, e.g. a smart phone, remote controller, portable electronic apparatus, light bulb, speaker, etc. The external apparatus 10 is not limited to the foregoing devices and includes all apparatuses that are able to be wirelessly connected to the electronic apparatus 1.

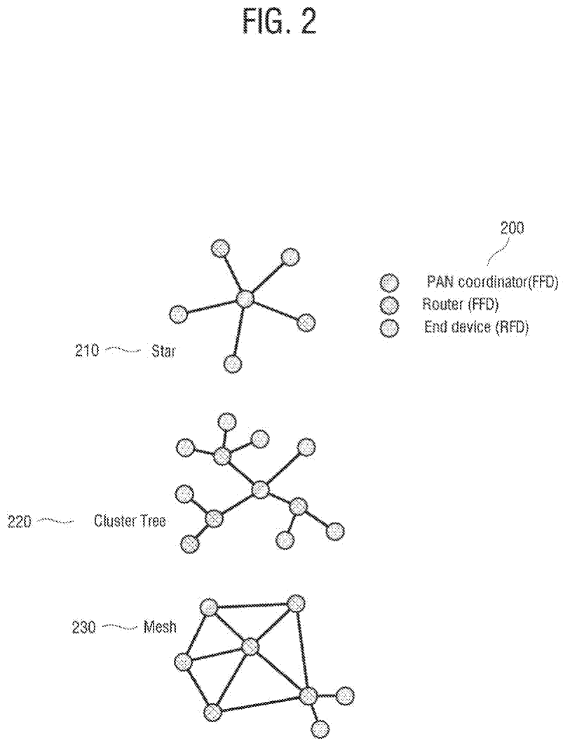

FIG. 2 illustrates a connection structure between the electronic apparatus and the external apparatus according to the embodiment of the disclosure. The electronic apparatus 1 which may serve as a coordinator forming and controlling a network may route data. There are a router which may communicate with another router and an end device, and an end device that communicates with the router or the coordinator. The external apparatus 10 according to the disclosure may serve as a router or an end device.

The connection structure between the electronic apparatus 1 and the external apparatus 10 includes three types: a star topology 210, a cluster-tree topology 220 and a mesh topology 230. The star topology 210 means a structure whereby another external apparatus 10 is directly connected to a single coordinator. The cluster tree topology 220 means a structure whereby a router or an end device is directly or indirectly connected to a coordinator. The mesh topology 230 means a structure whereby a router or an end device is connected to a coordinator through at least two communication routes.

The types of connection structures of the electronic apparatus 1 according to the embodiment of the disclosure are not limited to the foregoing and may include other types.

The electronic apparatus 1 which includes an operation performer 360 like a display or speaker may perform functions on its own. Meanwhile, the electronic apparatus 1 which does not include an operation performer 360 like a display or a speaker may not perform functions on its own.

The electronic apparatus 1 which may not perform functions on its own may do so indirectly through the external apparatus 10 wirelessly connected to the electronic apparatus 1. Hereinafter, the electronic apparatus 1 includes both the electronic apparatus 1 performing functions solely and the electronic apparatus 1 performing functions with the external apparatus 10 wirelessly connected to the electronic apparatus 1.

The electronic apparatus 1 according to the embodiment of the disclosure may perform a 1:N wireless communication rather than a 1:1 wireless communication in the wireless connection as above. In the structure of the 1:N wireless communication, it is advantageous from the perspective of security of communication that the electronic apparatus 1 may selectively be wirelessly connected to the external apparatus 10 that a user desires to wirelessly connect. Hereinafter, a configuration of the electronic apparatus 1 will be described.

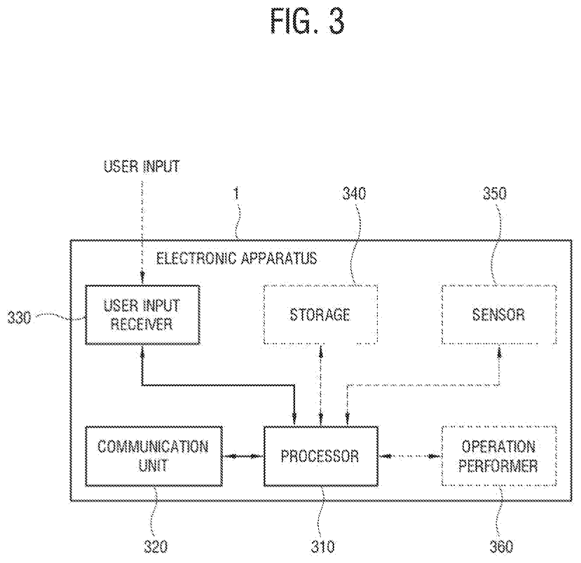

FIG. 3 is a block diagram of the electronic apparatus according to the embodiment of the disclosure. The electronic apparatus 1 includes a processor 310, a communication unit 320 and a user input receiver 330. In addition to the processor 310, the communication unit 320 and the user input receiver 330, the electronic apparatus 1 may further include elements such as a storage 340, a sensor 350 and an operation performer 360. However, the configuration of the electronic apparatus 1 according to the embodiment of the disclosure as shown in FIG. 3 is an example, and the electronic apparatus 1 according to the embodiment of the disclosure may be implemented as other configurations other than that shown in FIG. 3. That is, other configurations other than that in FIG. 3 may be added to, or any of the configuration in FIG. 3 may be excluded from, the electronic apparatus 1 according to the embodiment of the disclosure.

The communication unit 320 as a communicator may communicate with the external apparatus 10 according to a control of the processor 310. The communication unit 320 may be implemented by any of various communication methods. For example, the communication unit 320 may be configured to communicate by using at least one of various communication methods including Zigbee, Bluetooth, Wi-Fi, Ultra-Wide Band (UWB), wireless USB, and near field communication (NFC). The communication unit 320 may perform a function of a coordinator illustrated in FIG. 2. Otherwise, the communication unit 320 may elect to not perform a function of a coordinator, and another element of the electronic apparatus 1 may perform a function of a coordinator according to a control of the processor 310. Such another element may belong to the electronic apparatus 1 or may be an external element that is connected through a connection unit of the electronic apparatus 1.

According to a control of the processor 310, the user input receiver 330 receives an input of a user. The electronic apparatus 1 may directly receive a user input such as a user's manipulation and audio through the user input receiver 330. For example, the user input receiver 330 may include a touch screen, button, microphone, etc.

Otherwise, the electronic apparatus 1 may indirectly receive a user input through the communication unit 320. For example, the electronic apparatus 1 may receive a user input through a button of a remote controller or a microphone of a remote controller, and receive a user input converted into a digital signal, through the communication unit 320.

The electronic apparatus 1 may further include the storage 340. The storage 340 may store therein various information and store therein information that it has received from the outside, according to a control of the processor 310.

The electronic apparatus 1 may further include the sensor 350. The sensor 350 may detect an object. The object is a detected object corresponding to the external apparatus 10, and may be the external apparatus 10 itself or a particular object replacing the external apparatus 10. If the external apparatus 10 is relatively large in size or a sensitivity of the sensor 350 is high, the external apparatus 10 itself may be detected as an object. In the opposite case, it may be difficult to detect the external apparatus 10 itself, and the sensor 350 may detect an object replacing the external apparatus 10. In the latter case, the object may be a user holding the external apparatus 10 such as a mobile phone. The object is not limited to a user, and may include anything that is in the vicinity of the electronic apparatus 1 such as furniture. The object, which is detected by the sensor 350, may vary depending on the environment where the electronic apparatus 10 is placed or characteristics of the external apparatus 1 to be connected.

The sensor 350 includes a UWB radar sensor, an image sensor, an ultrasonic sensor and a laser sensor. The types of the sensor 350 are not limited to the foregoing, and may further include a sensor that detects an existence of an object and acquire location information of the object. For example, the sensor 350 may further include an image sensor being capable of an image or a user's location or movement, a movement sensor being capable of detecting vibration, a location sensor being capable of detecting a location, an illumination sensor being capable of detecting brightness, and a color sensor being capable of detecting a color. The illumination sensor or color sensor may also detect a user's movement. The electronic apparatus 1 may include the sensor 350 therein, or may together with or instead of the sensor 350, receive through the communication unit 320 a digital signal which has been converted from a result detected by an external sensor and has been transmitted to the electronic apparatus 1.

The electronic apparatus 1 may further include the operation performer 360. The operation performer 360 may include an output unit such as a display, speaker, and vibrator as an element for performing an operation or a function of the electronic apparatus 1 according to a control of the processor 310. Through the output unit such as the foregoing device, the operation performer 360 may output an image or an audio. The operation performer 360 is not limited to the foregoing element, and may further include other elements for performing other operations.

The processor 310 controls elements of the electronic apparatus 1 for their operations. The processor 310 may include a control program (or an instruction) enabling the performance of the foregoing control operation, a non-volatile memory in which a control program is installed, a volatile memory into which at least part of the installed control program is loaded and at least one processor or a central processing unit (CPU) for executing the loaded control program. The foregoing control program may be stored in other electronic apparatuses other than the electronic apparatus 1.

The control program may include a program(s) that is implemented as at least one of BIOS, device driver, operating system, firmware, platform and application program. According to an embodiment of the disclosure, the application program may be installed or stored in advance in the electronic apparatus 1 at the time of manufacturing of the electronic apparatus 1, or may be installed in the electronic apparatus 1 based on data of the application program transmitted from the outside at the time of use of the application program. The data of the application program may be e.g. downloaded from an external server such as an application market to the electronic apparatus 1. The external server is an example of a computer program product according to the embodiment of the disclosure, and the computer program product according to the embodiment of the disclosure is not limited to such external server.

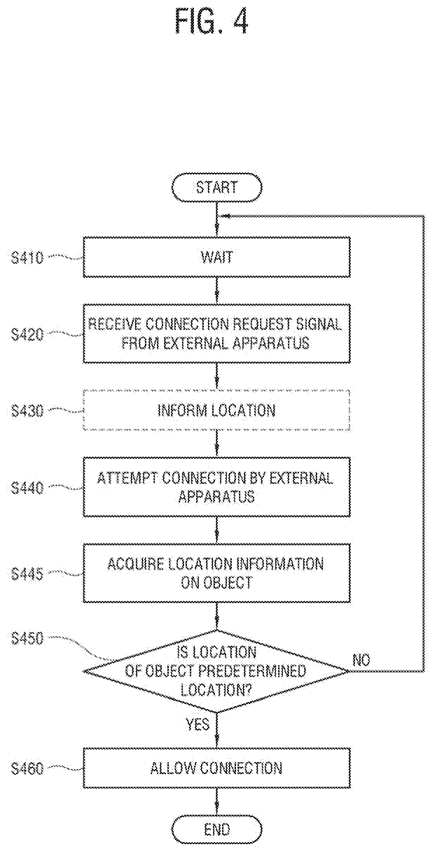

Hereinafter, operations of the electronic apparatus 1 according to the embodiment of the disclosure are described in detail. FIG. 4 is a flowchart showing operations of the electronic apparatus 1 according to the embodiment of the disclosure. The processor 310 waits for a connection request signal from the external apparatus 10 (S410). The processor 310 receives a connection request signal from the external apparatus 10 through the communication unit 320 or the user input receiver 330 (S420). The connection request signal is sent by the external apparatus 10 to the electronic apparatus 1 for a wireless connection between the external apparatus and the electronic apparatus 1. Upon receiving the connection request signal, the electronic apparatus 1 starts an operation for wireless connection.

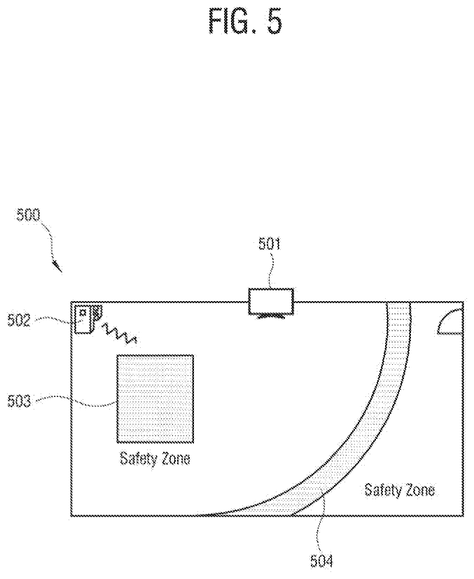

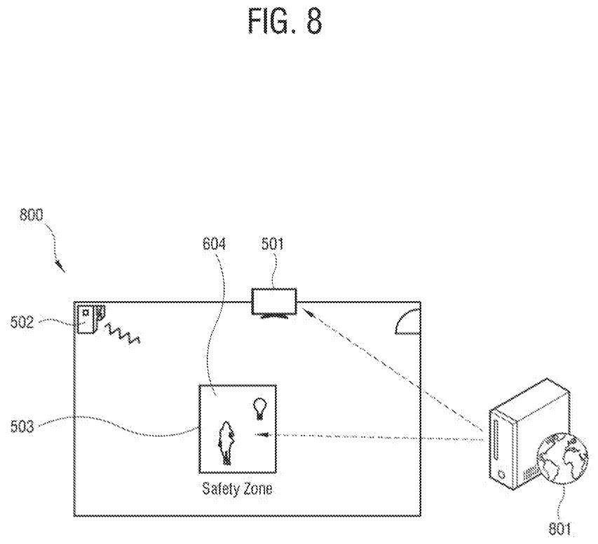

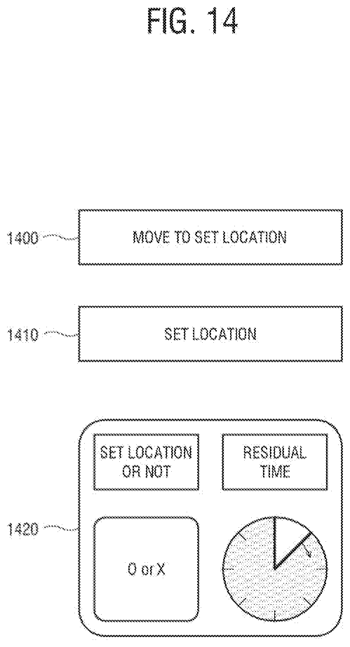

As the processor 310 receives the connection request signal, the processor 310 controls the operation performer 360 to inform a user of a location where a wireless connection is allowed (the ‘safety zone’), as an elective operation (S430). The safety zone may be determined in advance, or be determined upon request for wireless connection, or be determined upon occurrence of other particular events. The safety zone will be described in detail with reference to FIG. 5. The operation by the processor 310 to inform a user of the safety zone through the operation performer 360 will be described in detail with reference to FIGS. 8 and 14.

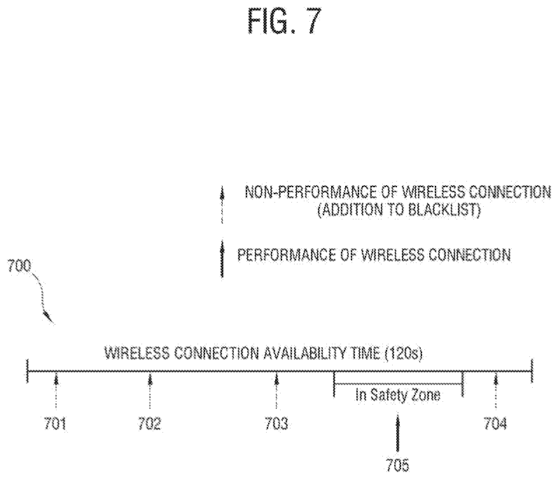

Referring to S440, after informing a user of the safety zone, the processor 310 checks whether the external apparatus 10 attempts to be connected to the electronic apparatus 1. If the external apparatus 10 attempts to be connected to the electronic apparatus 1 (S440), the processor 310 acquires location information of an object that is detected by the sensor 350 in the vicinity of the electronic apparatus 1 (S445). Based on the acquired location information, the processor 310 confirms whether the object is in the safety zone (S450). If it is confirmed that the object detected by the sensor 350 does not exist in the safety zone (‘No’ at operation S450), the processor 310 refuses to accept a connection request from the external apparatus 10 which has attempted to be wirelessly connected to the electronic apparatus 1, and waits for a new connection request signal from the external apparatus 10 (S410). If it is confirmed that the object exists in the safety zone (‘Yes’ at operation S450), the processor 310 allows the external apparatus 10, which has attempted to be wirelessly connected to the electronic apparatus 1, to be connected thereto (S460). When the connection is allowed, the processor 310 controls the communication unit 320 to transmit to the external apparatus information for completing the connection. A detailed operation by the processor 310 for determining whether the object exists in the safety zone will be described with reference to FIG. 7. As described above, as the processor 310 allows the connection of the external apparatus 10 only when the object exists in the safety zone, security for a wireless connection of the electronic apparatus 1 may be improved. Therefore, a user may selectively allow a wireless connection of the external apparatus 10 to the electronic apparatus 1 and may elect to not expose a security key. As a result, security of the electronic apparatus 1 may be improved in the course of a wireless connection.

FIG. 5 illustrates a safety zone relating to an electronic apparatus according to an embodiment of the disclosure. An electronic apparatus 501 in FIG. 5 receives a detection result of an object from a sensor 502 provided in the outside.

In an example of the electronic apparatus 501 in FIG. 5, there is a single detector 502. However, the detector 502 is not limited to the foregoing and may be plurally provided. The safety zone according to the embodiment of the disclosure may be within a certain distance from the detector 502. The range of the safety zone may be decided by the limit of distance that the detector 502 may detect, and to what extent the connection is allowed.

The safety zones 503 and 504 may include one or more zones. The safety zones 503 and 504 may have various shapes including a polygon and a closed surface. The safety zone 503 may be a two-dimensional zone as shown in FIG. 5 or a three-dimensional space. The safety zones 503 and 504 according to the embodiment of the disclosure are not limited to the foregoing examples and may further include other shapes of locations, zones or spaces.

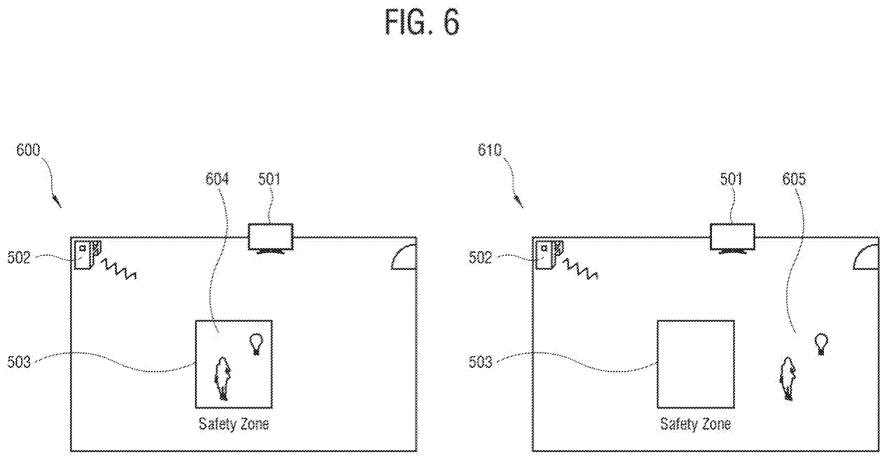

FIG. 6 illustrates operations of the electronic apparatus 1 according to the embodiment of the disclosure depending on a location of an object. As mentioned in operation S450 in FIG. 4, operations of the electronic apparatus 1 including an operation of determining whether an object exists in the safety zone 503 will be described in detail with reference to FIG. 6.

With respect to the electronic apparatus 1 in FIG. 6, description on elements identical or similar to the electronic apparatus 1 in FIG. 5 will be omitted. In FIG. 6, a case where an object 604 is in the safety zone 503 and a case where an object 605 is outside the safety zone 503 will be described in detail.

In an example of an electronic apparatus 601 in FIG. 6, the object may be, e.g. a user holding an external apparatus 10 to wirelessly connect to the electronic apparatus 601. If the object 604 is in the safety zone 503, the processor 310 may determine that the object 604 is in the safety zone 503 based on information on the object 604 detected through the detector 502 (see reference numeral 600). Meanwhile, if the object 604 is outside the safety zone 503, the processor 310 may determine that the object 605 is outside the safety zone 503 based on information on the object 605 detected through the detector 502 (see reference numeral 610). When the processor 310 determines whether the object 604 is in the safety zone 503, if information on a structure of an internal space is stored in the storage 340, or information may be additionally acquired through the communication unit 320, the processor 310 may more accurately determine a location of the object based on the information.

FIG. 7 illustrates another example of operations of the electronic apparatus 1 according to the embodiment of the disclosure. FIG. 7 is a graph visually showing a time during which the electronic apparatus 1 according to the embodiment of the disclosure allows a wireless connection of the external apparatus 10 (the ‘connection allowance time’) (see reference numeral 700). A processor 310 of the electronic apparatus 1 according to the embodiment of the disclosure confirms whether there is a valid connection attempt within the connection allowance time upon receiving a wireless connection request. Then, the processor 310 determines whether an object detected by the sensor 350 within the connection allowance time exists in the safety zone 503. That is, if connection attempts 701 to 704 are made out of the connection allowance time, or if the object does not exist in the safety zone even within the connection allowance time, the processor 310 does not allow a connection attempt, and only when the object detected during the connection allowance time exists in the safety zone, allows a connection attempt (705). In an example of the electronic apparatus 1 in FIG. 7, the connection allowance time is set at 120 seconds, and may vary depending on setting or communication method. Hereinafter, operations of the electronic apparatus within wireless connection availability time will be described in detail with reference to FIGS. 4 and 6.

Reference numerals 701 to 704 mean connection attempts made by the external apparatus 10 within wireless connection availability time while the object is outside the safety zone 503 (see reference numeral 605 in FIG. 6). The reference numeral 705 means a connection attempt made by the external apparatus 10 within the wireless connection availability time while the object is within the safety zone 503 (see reference numeral 604 in FIG. 6). The foregoing corresponds to ‘No’ at operation S450, and the processor 310 does not allow the attempt to perform the wireless connection (‘No’ at operation S450). A connection attempt made by the external apparatus 1 at the time when the object does not exist in the safety zone 503 may be a connection attempt made by a user having no valid authority. As the processor 310 imposes a limitation of the wireless connection availability time, security is improved more than the case where the connection is allowed only when the object is in the safety zone 503.

FIG. 8 illustrates an operation by the electronic apparatus according to the embodiment of the disclosure to introduce a predetermined location to a user. In FIG. 8, the operation by the electronic apparatus 1 to inform a user of the safety zone 503 referred to in FIGS. 4 and 6 will be described. With respect to the electronic apparatus 1 in FIG. 8, description on elements identical or similar to the electronic apparatus 1 described with reference to FIGS. 5 to 7 will be omitted. In FIG. 8, a process by the processor 310 to inform a user of information on the safety zone 503 and a relay device 801 other than the external apparatus 10 which performs a wireless connection with the electronic apparatus 1 will be described in detail.

The processor 310 may inform a user of a location of the safety zone 503 by various methods. First, the electronic apparatus 1 explains an operation of informing a user of a location of the safety zone 503. In the case of the electronic apparatus 1 which may output an audio or an image, the processor 310 may directly output a location of the safety zone 503 through an audio or an image.

In the case of the electronic apparatus 1 which may not output an audio or an image, the processor 310 may transmit to another device information on the safety zone 503 so that the another device may output the location. The another device may include, e.g. a relay device 801. The relay device 801 which may output an audio or an image may output a location of the safety zone 503 in favor of a user. The information on the location may include a user interface (UI), picture, image or audio.

If there is a device authorized by a user, the electronic apparatus 1 or the relay device 801 may transmit information on the safety zone 503 to the authorized device. The authorized device may be an example of the relay device 801.

The relay device 801 may be in the same place as the electronic apparatus 1 or in a different place from the electronic apparatus 1. If a user is informed by the relay device 801 rather than the electronic apparatus 1 of location information, it is difficult for other users to access the location information, and thus security may be improved.

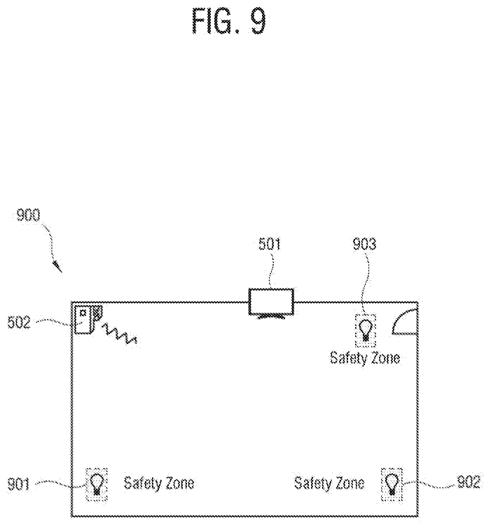

FIG. 9 illustrates operations of an electronic apparatus according to an embodiment of the disclosure. With respect to the electronic apparatus 1 in FIG. 9, description on elements identical or similar to the electronic apparatus 1 described with reference to FIG. 5 will be omitted. In FIG. 9, a process of setting a safety zone 503 by the processor 310 will be described. If the safety zone 503 is not set in advance, the processor 310 may set the safety zone 503 by using location information by the following method. One or more safety zones 901, 902 and 903 may be set (see reference numeral 900).

The processor 310 may receive location information through a user input. The processor 310 may set the safety zone 503 corresponding to the received location information. The user input may be a UI or audio. The location information received through a user input may be a particular location or information on a particular object. The processor 310 may also receive a user input through a relay device 801 (in FIG. 8) connected to the electronic apparatus 1 through communication.

The processor 310 may set the safety zone 503 by receiving location information from another external apparatus such as a server rather than from the external apparatus 10 which is to be connected to the electronic apparatus 1. In such case, the another external apparatus such as a server may provide to the electronic apparatus 1 location information reflecting information on use environment. The processor 310 may set the safety zone 503 based on location information transmitted by the another external apparatus such as a server.

After calculating location information through an inherent algorithm, etc., the processor 310 may set the safety zone 503 corresponding to the calculated location information. When calculating the location information, the processor 310 may consider a use environment of a user, an object to be connected, a detected object, etc.

By the same method as described above, the processor 310 may set the safety zone 503 which is convenient for a user. Also, the safety zone 503 may be unexposed to another person.

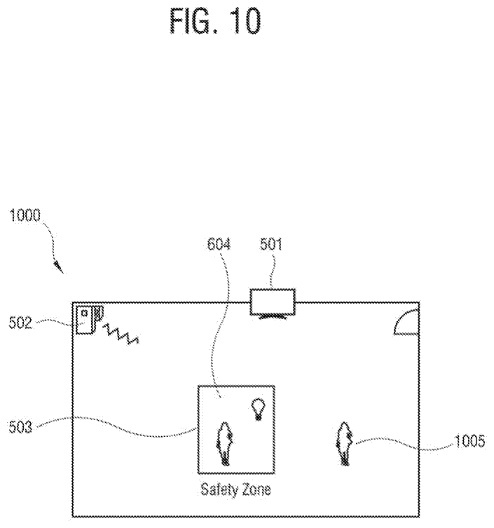

FIG. 10 illustrates an operation of an electronic apparatus according to an embodiment of the disclosure. With respect to the electronic apparatus 1 in FIG. 10, description on elements identical or similar to the electronic apparatus 1 described with reference to FIGS. 5 and 6 will be omitted. In FIG. 10, an operation of the electronic apparatus 1 in the case where there are two or more objects detected by the sensor 350 will be described. Hereinafter, an embedment whereby the electronic apparatus 1 does not perform a wireless connection in case there are two or more objects 604 and 1005 will be described.

FIG. 10 illustrates a person as an object for convenience of description, but the first object 604 and the second object 1005 may be persons or external apparatuses 10. In the space where the safety zone 503 exists, there may be the second object 1005 having a malicious purpose unlike the first object 604 (see reference numeral 1000). If the external apparatus 10 attempts to be wirelessly connected to the electronic apparatus 501 while the first object 604 exists in the safety zone 503, the processor 310 may elect to not perform a connection to the external apparatus 10. Even if the external apparatus 10 attempts to perform a connection while the second object 1005 exists in the safety zone 503, the processor may elect to not perform a connection. As a result, the second object 1005 having a malicious purpose may not know the location or existence of the safety zone 503. Also, as the processor 310 does not perform a wireless connection to all of the external apparatuses 10, security may be improved against the malicious second object 1005.

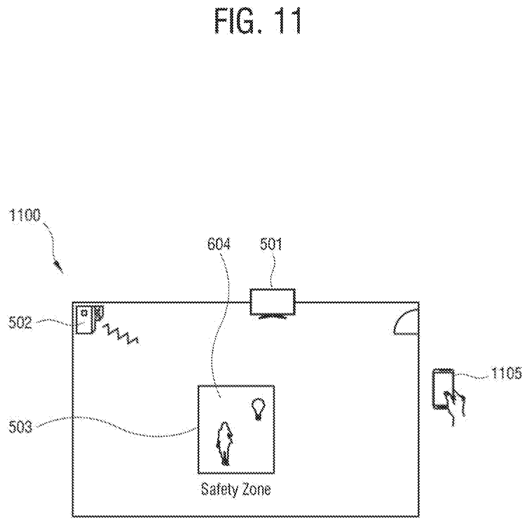

FIG. 11 illustrates an operation of an electronic apparatus according to an embodiment of the disclosure. With respect to the electronic apparatus 1 in FIG. 11, description on elements identical or similar to the electronic apparatus 1 described with reference to FIG. 6 will be omitted. In FIG. 11, an operation of the electronic apparatus 1 against an external apparatus 10 which attempts to perform a wireless connection outside a particular space will be described.

There is an external apparatus 1105 that attempts to be connected to the electronic apparatus 1 outside a space where the electronic apparatus 1 is located (see reference numeral 1100). If the external apparatus 1105 attempts to be connected while an object 604 exists in the safety zone 503, the processor 310 may refuse to accept the connection by the external apparatus 1105. The processor 310 may determine whether the external apparatus 1105 is located outside the space by using location information of the external apparatus 1105 and space information on the space where the electronic apparatus 1 is located.

The location information on the external apparatus 10 may be obtained by calculating a received signal strength indication, etc. The space information may be obtained by storing or setting in advance information on the space where the safety zone 503 is located. If the processor 310 determines that the external apparatus 10, which attempts to be connected to the electronic apparatus 1, is beyond a predetermined distance or outside a particular space, based on location information and space information, the processor 310 may refuse to accept the connection attempt by the external apparatus 10. The processor 310 may refuse to accept a connection attempt made outside a particular zone, by considering a distance and direction. As the electronic apparatus 1 does not perform a connection with the external apparatus 10 outside a particular space, security may be improved.

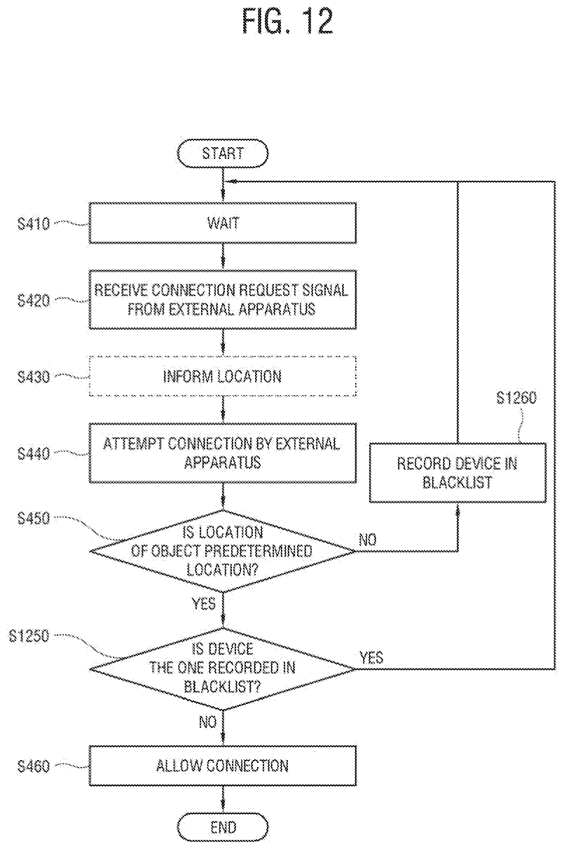

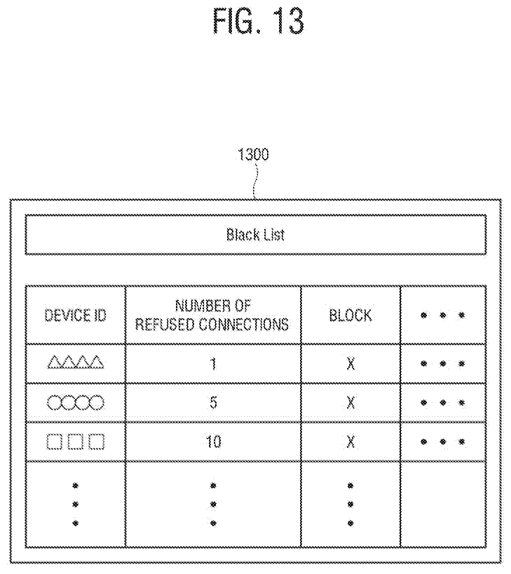

FIG. 12 is a flowchart showing operations of the electronic apparatus according to the embodiment of the disclosure. With respect to the electronic apparatus 1 in FIG. 12, description on elements identical or similar to the electronic apparatus 1 described with reference to FIG. 4 will be omitted. In FIG. 12, an operation of determining by the processor 310 whether the external apparatus 10 is an object that will be added, or has been added, to a blacklist will be described. Description on FIG. 13 illustrating a UI for a blacklist will follow the description on FIG. 12.

Upon a connection attempt by the external apparatus 10 (S440), the processor 310 determines whether a location of an object corresponds to an agreed location. If it is determined that the location of the object does not correspond to the agreed location (‘No’ at operation S450), the processor 310 blocks a connection of the external apparatus 10 which has attempted to be wirelessly connected. The processor 310 may store in the storage 340 identification information on the external apparatus 10 and use such identification information as a blacklist. The processor 310 records the external apparatus 10 in the blacklist by using the stored identification information (S1260), and waits for another connection request signal. An example of recording by the processor 310 the external apparatus 10 in the blacklist will be described in detail following the description on the flowchart. If it is determined that the location of the object corresponds to a predetermined location (‘Yes’ at operation S450), the processor 310 determines whether the external apparatus 10, which attempts to be connected, is recorded in the blacklist (S1250). If it is determined that the external apparatus 10, which has attempted to be connected, is the one recorded in the blacklist (‘Yes’ at operation S1250), the processor 310 refuses to accept the connection attempt by the apparatus, and waits for a wireless connection request signal of another external apparatus 10. If it is determined that the external apparatus 10, which has attempted to be wirelessly connected, is not the one recorded in the blacklist (‘No’ at operation S1250), the processor 310 controls to complete a wireless connect by responding to the wireless connection attempt by the apparatus (S460).

An example of adding the external apparatus 10 to the blacklist by the processor 310 will be described in detail with reference to FIG. 7. In reference numeral 700, if the external apparatus 10 attempts to perform a wireless connection on the condition of reference numeral 701, as the object does not exist in the safety zone 503, the processor 310 may elect to not perform the connect in reference numeral 701. If the same external apparatus 10 attempts to perform a connection in reference numerals 702, 703 and 704 like in reference numeral 701, the processor 310 may likewise refuse to accept the connection. However, if the external apparatus 10 attempts to perform a connection as in reference numeral 705 while the object exists in the safety zone 503, the processor 310 may accept such connection. Therefore, with respect to the connection attempted by the external apparatus 10 in a section which is not the connection allowance time, the processor 310 may refuse to accept such connection attempted by the external apparatus 10, and thereafter add the external apparatus 10 to the blacklist and may refuse the connection of the external apparatus 10 that has been added to the blacklist. The processor 310 may store in the storage 340 the blacklist and information on the external apparatus 10 added to the blacklist.

The condition on which the processor 310 adds to the blacklist the external apparatus 10 that attempts a connection is not limited. If an object does not exist in the safety zone 503 at the time when the external apparatus 10 initially attempts to be connected, the processor 310 may add the external apparatus 10 to the blacklist. Otherwise, the processor 310 may add the external apparatus 10 to the blacklist if the external apparatus 10 repeatedly attempts to be connected. Otherwise, the processor 310 may add the external apparatus 10 to the blacklist if the external apparatus 10, which is outside a particular zone described in FIG. 11, attempts to be wirelessly connected. As above, the condition on which the processor 310 adds the external apparatus 10 to the blacklist is not limited, and may be replaced with other conditions or may be supplemented by other conditions.

FIG. 13 illustrates an operation of adding a blacklist by an electronic apparatus according to an embodiment of the disclosure. In FIG. 13, an example of adding a blacklist by a processor 310 is described. In reference numeral 1300, the blacklist may be recorded with a device ID, the number of refused connections, and registration or non-registration in the blacklist. The blacklist is not limited to the foregoing, and the processor 310 further record a distance from the electronic apparatus 1, type of device or the number of connections, etc. As an example of adding the external apparatus 10 to the blacklist by the processor 310, the processor 310 may add a device to the blacklist if the number of refused connections on a cumulative basis with respect to the device is 10 or more as in reference numeral 1300. Otherwise, if the external apparatus 10 which is located at a predetermined distance or more from the electronic apparatus 1 attempts to be wirelessly connected to the electronic apparatus 1, the processor 310 may add the external apparatus 10 to the blacklist. Otherwise, if the external apparatus 10 attempts to be wirelessly connected outside a particular zone, the processor 310 may add the external apparatus 10 to the blacklist. Otherwise, the processor 310 may receive a user input, and based on that may add the external apparatus 10 to the blacklist or may edit the blacklist.

FIG. 14 illustrates a content output by an electronic apparatus according to an embodiment of the disclosure. By outputting an audio or an image through an output unit included in the operation performer 360, the processor 310 may inform a user to move to a set location, or require a user to set a location, or inform whether the location of an object is currently in the safety zone 503 or how long the wireless connection availability time is left.

Reference numeral 1400 shows a content requiring a user to move to the safety zone 503 through an audio or an image if the location is set. The content may be directly output by the electronic apparatus 1 or may be indirectly output through the relay device 801.

Reference numeral 1410 shows a content requiring a user to set a location through an audio or an image if the safety zone 503 is not set. If a user is to set the location, the processor 310 may output a content requiring a user to set the location as in reference numeral 1410.

Reference numeral 1420 shows a content informing whether the object is in the safety zone 503 or how long residual time allowed for wireless connection is left if the location is set and the wireless connection allowance time is ongoing. Whether the object is in the set location may be represented as O or X as in reference numeral 1420 but not limited thereto. Whether the object is in the safety zone may be otherwise represented as a color, letter, shape, audio, etc. The residual time allowed for wireless connection may be represented as colors in a circle as in reference numeral 1420, but not limited thereto. The residual time allowed for wireless connection may be represented as numbers, letters, audio, etc. The method of outputting by the operation performer 360 of the electronic apparatus 1 is not limited.

1. An electronic apparatus comprising:
a communicator configured to communicate with at least one external apparatus; and
a processor configured to:
control the communicator to start a connection with the at least one external apparatus,
acquire location information on an object detected in a vicinity of the electronic apparatus,
accept the started connection depending on whether the object exists in a zone in which the connection is allowed, based on the acquired location information, and
transmit to the external apparatus information for completing the connection based on the connection being allowed.

2. The electronic apparatus according to claim 1, wherein the processor is configured to identify whether the object exists in the zone in which the connection is allowed, within a predetermined connection allowance time.

3. The electronic apparatus according to claim 1, further comprising:
an output unit configured to output an audio or an image,
wherein the processor is configured to output the zone in which the connection is allowed, through the output unit.

4. The electronic apparatus according to claim 1, wherein the processor is configured to transmit information on the zone in which the connection is allowed, to enable another external apparatus to output the zone in which the connection is allowed.

5. The electronic apparatus according to claim 1, further comprising:
a user input configured to receive a user's input,
wherein the processor is configured to set the zone in which the connection is allowed, corresponding to a received user's input.

6. The electronic apparatus according to claim 1, wherein the processor is configured to set the zone in which the connection is allowed, by using an external apparatus rather than the electronic apparatus.

7. The electronic apparatus according to claim 1, wherein the processor is configured not to perform a connection based on two or more objects being existed.

8. The electronic apparatus according to claim 1, wherein the processor is configured not to perform a connection with the external apparatus based on a distance of the external apparatus from the electronic apparatus exceeding a threshold value at the time when at least one external apparatus attempts to be connected to the electronic apparatus.

9. The electronic apparatus according to claim 1, wherein in a situation where the object does not exist in the zone in which the connection is allowed, based on the external apparatus attempting to be connected to the electronic apparatus, the processor is configured to block the connection attempted by the external apparatus, store identification information on the external apparatus which has attempted to be connected, and block a connection subsequently attempted by the external apparatus based on the stored identification information.

10. A method for controlling an electronic apparatus comprising:
controlling a communicator which may communicate with at least one external apparatus to start a connection with at least one external apparatus;
acquiring location information on an object detected in a vicinity of the electronic apparatus;
allowing the started connection depending on whether the object exists in a zone in which the connection is allowed, based on the acquired location information; and
transmitting information for completing the connection to the at least one external apparatus, based on the started connection being allowed.

11. The method according to claim 10, further comprising:
determining whether the object exists in the zone in which the connection is allowed, within a predetermined connection allowance time.

12. The method according to claim 10, further comprising:
outputting the zone in which the connection is allowed, through an output unit for outputting an audio or an image.

13. The method according to claim 10, further comprising:
transmitting information on the zone in which the connection is allowed, to output by another external apparatus the zone in which the connection is allowed.

14. The method according to claim 10, further comprising:
setting the zone in which the connection is allowed, corresponding to a user's input received through a user input.

15. The method according to claim 10, further comprising:
setting the zone in which the connection is allowed, by using an external apparatus rather than the electronic apparatus.
